(19) United States
(12) Patent Application Publication
(10) Pub. No.: US 2005/0221261 A1
(43) Pub. Date: Oct. 6, 2005

(54) System and method that provide multiple information clues for learning chinese spelling

(76) Inventors: Sayling Wen, Taipei (TW); Zechary Chang, Taipei (TW); Harry Han, Beijing (CN); Amy Zhang, Beijing (CN)

Correspondence Address: BIRCH STEWART KOLASCH & BIRCH, PO BOX 747, FALLS CHURCH, VA, 22040-0747, US

(21) Appl. No.: 10/814,140

(22) Filed: Apr. 1, 2004

(51) Int. Cl. G09B 5/00; G09B 19/00

(52) U.S. Cl. 434/169

(57) ABSTRACT

A spelling learning system and the corresponding method that provide multiple information clues for learning Chinese spelling are disclosed. A problem generating module extracts clues from a spelling database according to the current difficulty level and displays them to the learner. The system receives an input from the user within a predetermined time. The result comparison module compares the input with the original spelling data. If the input is correct, the system notifies the user. Therefore, the invention provides learners a progressive, interesting learning method for learning the Chinese spelling.

### BACKGROUND OF THE INVENTION

1. Field of Invention

The invention relates to a spelling learning system and method. More particularly, the invention relates to a system and method for learning Chinese spelling through typewriting practices.

2. Related Art

Chinese spelling is the basic of learning Chinese and computer inputs. Throughout the specification, we use Chinese spelling to refer to the phonetic spelling of Chinese characters. It would be extremely inconvenient in work, learning and life if one does not know Chinese spelling. Chinese spelling is normally taught by teachers in schools. It is somewhat difficult if one wants to learn it own his or her own. Moreover, to understand the Chinese spelling principles is an extremely boring process. Therefore, it is very hard for learners to continue making progresses.

Currently, there are very few teaching and learning products about Chinese spelling on the market because it receives little attention. Most teaching remains on static paper works. Static information plus boring contents often result in students' visual and spiritual fatigues. This is very hard to stimulate the learner's enthusiasm in learning. With the advance in modern technologies, some multimedia products have been introduced. However, such products are mostly video products that have some drawbacks. For example, the documents occupy larger space and cannot vividly describe things, especially for abstract ideas such as spelling.

Therefore, how to properly make use of the advantages of computers to arouse learners' interest to make continuous progresses in Chinese spelling is an important subject.

### SUMMARY OF THE INVENTION

In view of the foregoing, the invention provides a system and the corresponding method for learning Chinese spelling through typewriting practices. A primary objective of the invention is to use the mature computer technology to provide a method for learners to learn Chinese spelling in a simple and interesting way so that the learners do not have tiredness feelings that may affect the learning effects.

To achieve the above objective, the disclosed spelling typewriting learning system with multiple information clues includes: a spelling database, which stores more than one set of original spelling datum and a plurality of associated clues; a problem generating module, which extracts an original spelling datum along with the associated clues from the spelling database according to a current difficulty level; a display module, which displays the clues according to the current difficulty level within a predetermined time; an input receiving module, which accepts an input from the learner within a predetermined time; and a result comparison module, which compares the learner's input with the original spelling datum of the problem generating module and outputs a comparison result.

Furthermore, the invention provides a typewriting spelling method with multiple information clues. First, the system displays clues associated with a spelling datum according to the current difficulty level. It receives an input from the user within a predetermined time for the current difficulty level. The system compares the input with the spelling datum. If the comparison result is correct, the system notifies the user.

According to the disclosed system and method, the boring Chinese spelling learning process is made more interesting to help learners mastering the materials in a short period of time. Through the division of difficulty levels, the invention provides learners a progressive learning scheme. At the same time of learning Chinese spelling, the learner also practices keyboard inputs, further enhancing the learning effects and stimulating the learner's enthusiasm in learning.

### BRIEF DESCRIPTION OF THE DRAWINGS

The invention will become more fully understood from the detailed description given hereinbelow illustration only, and thus are not limitative of the present invention, and wherein:

FIG. 1 shows the structure of the disclosed typewriting spelling learning system with multiple information clues;

FIG. 2 is a flowchart of the disclosed typewriting spelling learning method with multiple information clues;

FIG. 3 is a flowchart of the disclosed embodiment; and

FIGS. 4A through 4F are schematic view of the interface according to the embodiment.

### DETAILED DESCRIPTION OF THE INVENTION

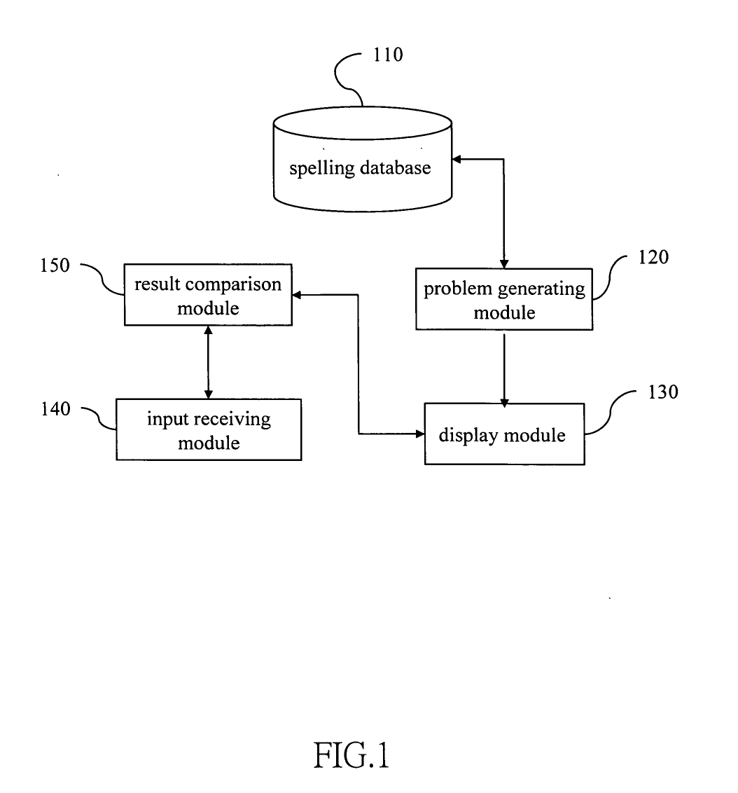

Please refer to FIG. 1 for a description of the module structure of the disclosed typewriting spelling learning system. The system includes: a spelling database 110, a problem generating module 120, a display module 130, an input receiving module 140, and a result comparison module 150.

(1) The spelling database 110 stores several original spelling data and several clues associated with each of the original spelling data for generating problems. The clues include graphics, text, sounds, spelling display, and intonation.

(2) The problem generating module extracts clues from the spelling database according to a difficulty level. Different difficulty levels correspond to different clue combinations. The higher difficulty level it is, the fewer clues the system will provide.

(3) The display module 130 displays clues within a predetermined time according to the difficulty level. The clues are displayed in a free-fall manner: each of them starts from the top of the screen and then falls down freely. At the same time, the system starts timing. Once the time has passed (different time intervals for different levels of difficulty), the provided clues disappear at the bottom of the screen.

(4) The input receiving module 140 receives the input from the learner within a predetermined time. In other words, the user can enters his or her answer while the clues are still displayed on the screen.

(5) The result comparison module 150 makes a real-time comparison between the learner's inputs with the original spelling data of the problem generating module and obtains a comparison result. If the user enters a correct spelling within the predetermined time, the display module finishes the clue display and thus the provided clues disappear from the bottom of the screen

In the above-mentioned system, the difficulty level is preset by the user. Of course, it can be automatically adjusted according to the user's ability. The disclosed system can further contain a difficulty level adjusting module for adjusting the difficulty level according to the comparison result.

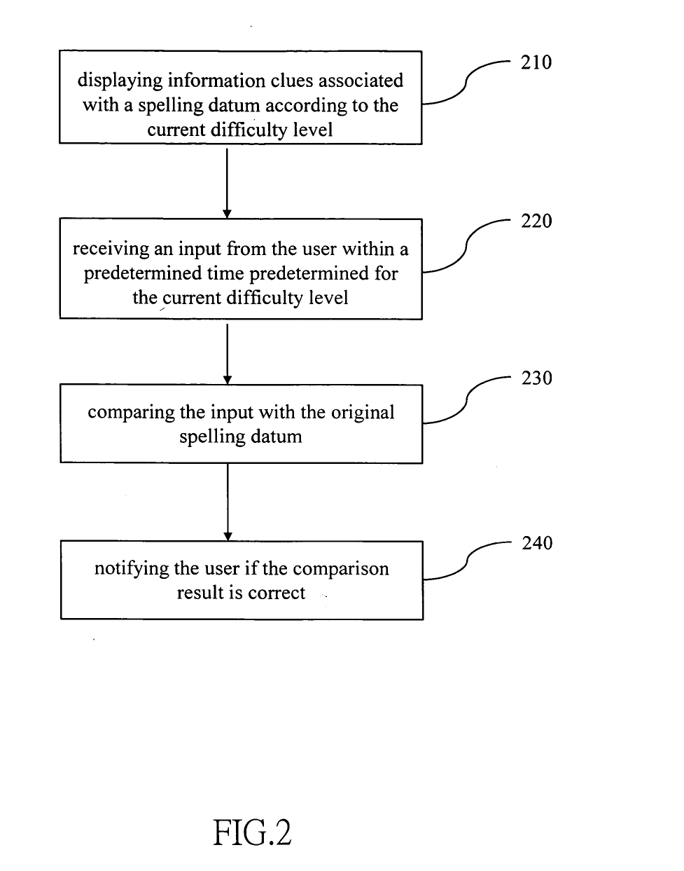

With reference to FIG. 2, the disclosed typewriting spelling learning method runs as follows. First, the system displays clues associated with the spelling datum according to the current difficulty level (step 210). Within the predetermined time for the current difficulty level, the system receives an input from the user (step 220). The system then compares the input with the spelling datum (step 230). If the comparison result is correct, then the system notifies the user (step 240).

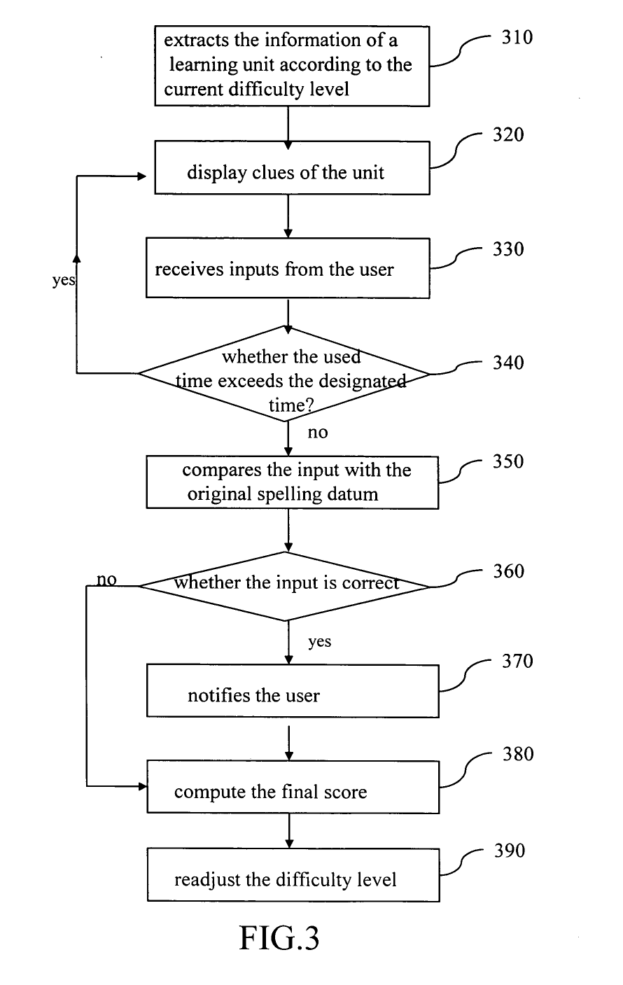

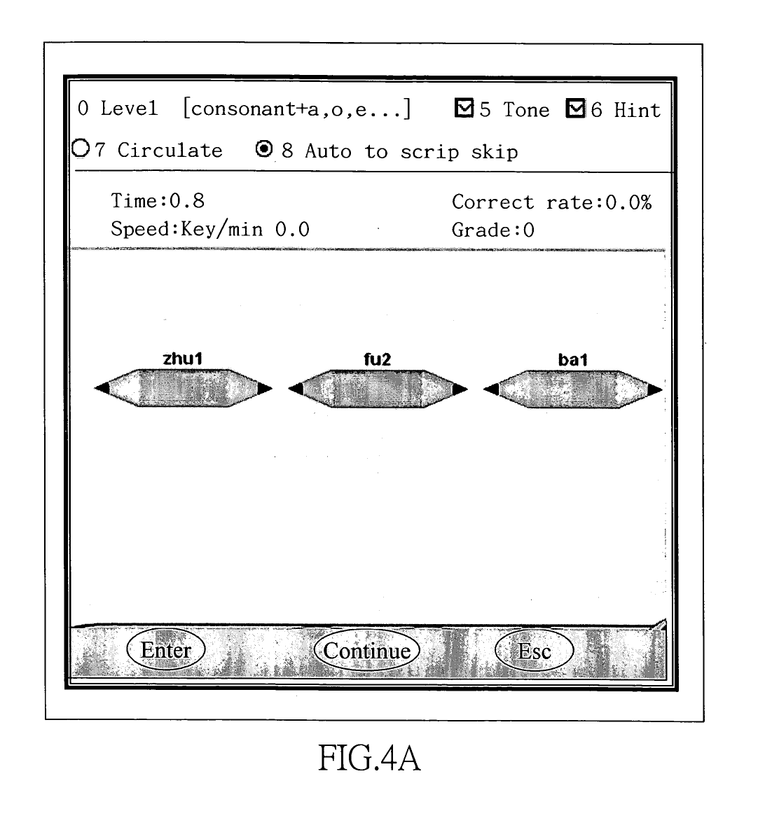

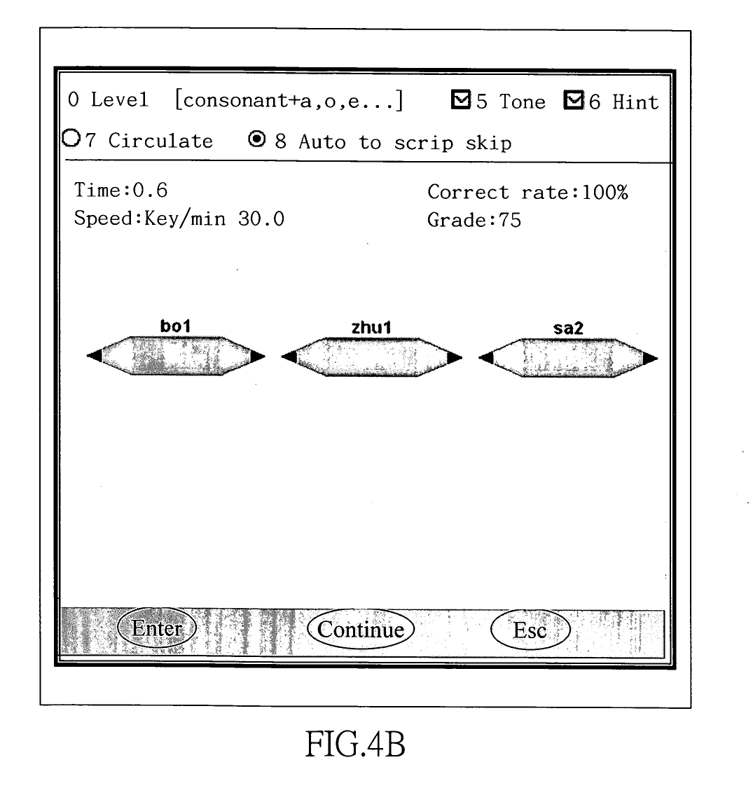

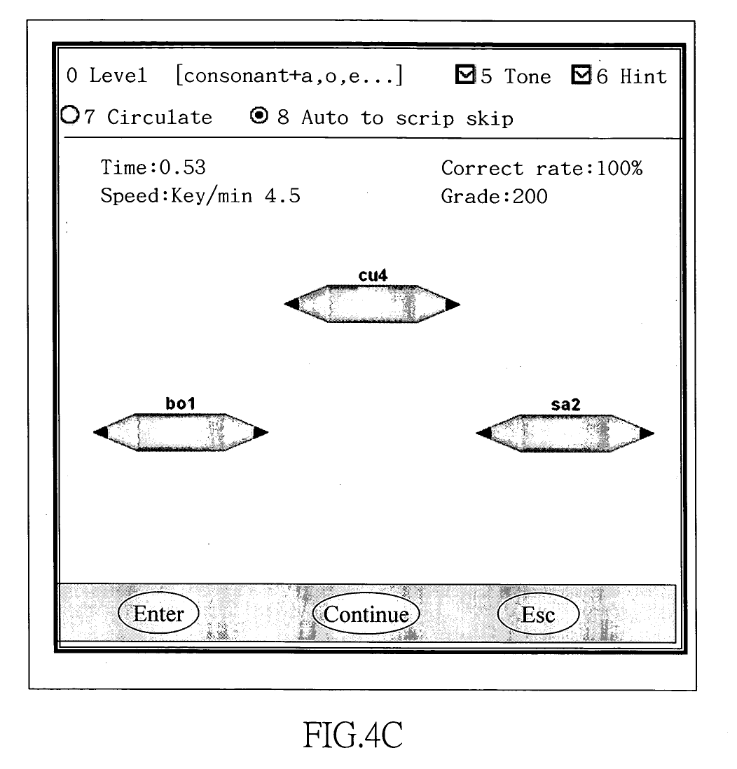

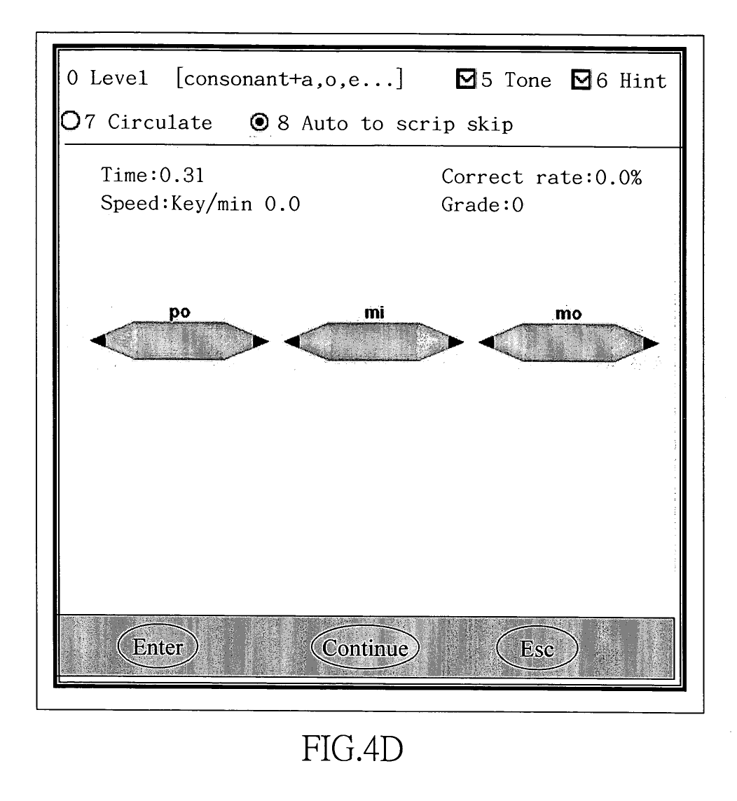

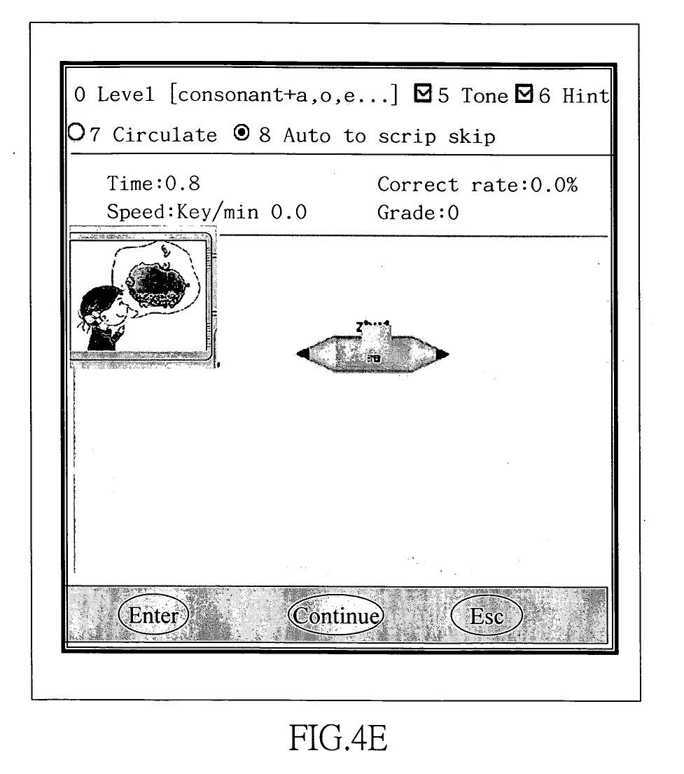

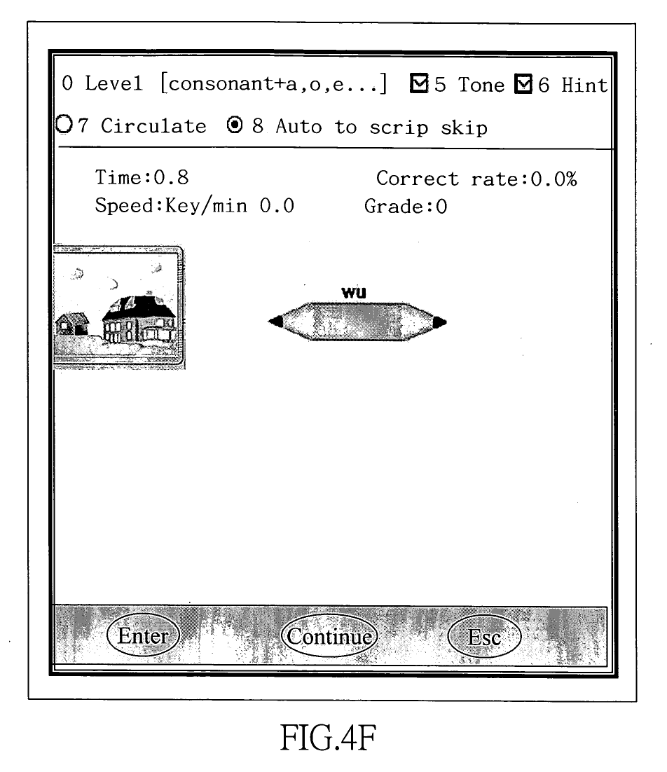

An explicit embodiment of the invention is shown in FIG. 3. First, according to the current difficulty level the system extracts the information of a learning unit (step 310). Clues of the unit are displayed in order (step 320). The interfaces of the embodiment are shown FIGS. 4A to 4F. The clues can be graphics, text, sounds, spelling display, and intonation. From FIG. 4A, one sees that the moving pencil has such clues as spelling display, and intonation. It can also have sounds, pictures, and other information. The pencil with clues falls freely in such way that it is displayed in a predetermined time. Initially, it appears at the top of the screen. As time goes on, it falls toward the bottom of the screen. At the designated time, it arrives at the bottom of the screen and disappears. During the falling period, the system receives inputs from the user (step 330). The learner uses the keyboard to enter the letters and numbers corresponding to the spelling and intonation. The system starts timing from the time the clues appear, determining whether the used time exceeds the designated time (step 340). Once the designated time is over, the system does not accept the user's input and the clues disappear from the screen. If the designated time is not over yet, the system compares the input with the original spelling datum (step 350) and determines whether the input is correct (step 360). If the user's input is determined to be correct, then the system notifies the user (step 370). As shown in FIG. 4B, the correct input content is displayed in red, or the word and pencil icon disappear. The system then goes on to the next associated clue, as shown in FIG. 4C. If the input is not correct, the screen does not have any change but the input is recorded for scoring. The final score is computed (step 380) and used to adjust the difficulty level (step 390). In particular, different levels of difficutly correspond to different clue combinations. The higher the difficulty level is, the fewer clues the system will provide. If the final score indicates that the user input has a sufficiently high correctness rate, the difficulty level is raised correspondingly. As shown in FIG. 4D, the clues in the drawing does not include intonation. The learner has to determine the intonation by him- or herself. Thus, the difficulty level is higher.

In the invention, one can add graphics into the clues to increase the fun of learning. Please refer to FIGS. 4E and 4F. The interface shown in FIG. 4E contains a picture of a piglet. The learner enters in order the letters “z”, “h”, and “u.” If the user entered message cannot be found in the current screen, then it is not displayed. However, it is taken into account for the correctness rate and the score. When the spelling entered by the learner is the same as a particular word, the entered spelling letters become red. When “zhu1” is corrected entered by the user, the text and pencil icon disappear. The system goes on to the next word. Please see FIG. 4F. The drawing shows the interface of the next associated clue. The drawing also has a picture of a house. The display of pictures can further intensify the memory of the learner.

During the practice process, the learner can choose to do all problems in a unit. The user can also choose to change to another level automatically when his or her score reaches a standard in the current difficulty level. The learner can also make his or her own selections on difficulty levels.

Certain variations would be apparent to those skilled in the art, which variations are considered within the spirit and scope of the claimed invention.

1. A typewriting spelling learning system that provides multiple information clues, which comprises:
a spelling database, which stores more than one set of original spelling datum and a plurality of associated clues;
a problem generating module, which extracts an original spelling datum along with the associated clues from the spelling database according to a current difficulty level;
a display module, which displays the clues according to the current difficulty level within a predetermined time;
an input receiving module, which accepts an input from the learner within a predetermined time; and
a result comparison module, which compares the learner's input with the original spelling datum of the problem generating module and outputs a comparison result.

2. The system of claim 1 further comprising a difficulty level adjusting module for adjusting the difficulty level according to the comparison result.

3. The system of claim 1, wherein the clues include any combination of graphics, text, sound, spelling display and intonation.

4. The system of claim 1, wherein the display module displays the clues in a free-fall manner.

5. The system of claim 1, wherein the difficulty level is preset by the user.

6. The system of claim 1, wherein the display module terminates the display of the clues if the comparison result is correct.

7. A typewriting spelling learning method that provides multiple information clues, which method comprises the steps of:
displaying information clues associated with a spelling datum according to the current difficulty level;
receiving an input from the user within a predetermined time predetermined for the current difficulty level;
comparing the input with the original spelling datum; and
notifying the user if the comparison result is correct.

8. The method of claim 7 further comprising the step of adjusting the difficulty level according to the comparison result.

9. The method of claim 8, wherein the difficulty level is preset by the user.

10. The method of claim 7, wherein the clues include any combination of graphics, text, sound, spelling display and intonation.

11. The method of claim 7, wherein the display module displays the clues in a free-fall manner within a predetermined time.

12. The method of claim 7, wherein the step of notifying the user is displaying the user's input.

13. The method of claim 7, wherein the step of notifying the user is finishing the information clue display.
